(19) United States
(12) Patent Application Publication
(10) Pub. No.: US 2016/0312863 A1
(43) Pub. Date: Oct. 27, 2016

(54) COMPOSITE TENSIONER ARM OR GUIDE FOR TIMING DRIVE APPLICATION

(71) Applicant: BORGWARNER INC., Auburn Hills, MI (US)

(72) Inventor: Sean SIMMONS, Cortland, NY (US)

(21) Appl. No.: 15/103,724

(22) PCT Filed: Dec. 15, 2014
(86) PCT No.: PCT/US2014/070333

§ 371 Date: Jun. 10, 2016

Related U.S. Application Data
(60) Provisional application No. 61/916,436, filed on Dec. 16, 2013.

(51) Int. Cl. F16H 7/18; F16H 7/08

(52) U.S. Cl. CPC F16H 7/18; F16H 7/08; F16H 2007/185; F16H 2007/0872

(57) ABSTRACT

A body of a tensioner arm or guide having a plurality of layers of continuous fiber material. Each layer has fibers oriented in a single direction and extending a majority of a length or width of the material. The fibers of each of the plurality of layers are oriented in a direction other than the orientation of the fibers of adjoining layers of the plurality of layers.

### REFERENCE TO RELATED APPLICATIONS

This application claims one or more inventions which were disclosed in Provisional Application No. 61/916,436, filed Dec. 16, 2013, entitled “COMPOSITE TENSIONER ARM OR GUIDE FOR TIMING DRIVE APPLICATION”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of tensioner arms or guides. More particularly, the invention pertains to a composite tensioner arm or guide for a timing driving application.

2. Description Of Related Art

Many prior art tensioner arms or guides are made of steel or thermoplastic/resin reinforced with fibers. The fibers may be short or long and are interspersed throughout the thermoplastic or resin. The fibers may consist of glass, graphite, aramid, or carbon.

### SUMMARY OF THE INVENTION

A body of a tensioner arm or guide having a plurality of layers of continuous fiber material. Each layer has fibers oriented in a single direction and extending a majority of a length or width of the material. The fibers of each of the plurality of layers are oriented in a direction other than the orientation of the fibers of adjoining layers of the plurality of layers.

### BRIEF DESCRIPTION OF THE DRAWINGS

FIG. 1 shows a perspective view of a tensioner arm made from continuous fiber materials.

FIG. 2 shows another perspective view of a tensioner arm made from continuous fiber materials.

FIG. 3 shows side view of a tensioner arm made from continuous fiber materials.

FIG. 4 shows a perspective view of a guide made from continuous fiber materials.

FIG. 5 shows another perspective view of a guide made from continuous fiber materials.

FIG. 6 shows a side view of a guide made from continuous fiber materials.

FIGS. 7a and 7b shows a schematic of layering the unidirectional tape. FIG. 7b shows a cross-section of FIG. 7a.

FIG. 8 shows a portion of a tensioner arm body of a first embodiment.

FIG. 9 shows a portion of a tensioner arm body with an increased thickness a second embodiment.

FIG. 10 shows a portion of tensioner arm of another embodiment in which two bodies are attached through continuous fiber materials.

FIG. 11 shows a portion of an “I” shaped tensioner arm made of multiple continuous fiber materials.

FIG. 12 shows a “C” shaped tensioner arm made of multiple continuous fiber materials.

FIG. 13 shows a box shaped tensioner arm made of multiple continuous fiber materials.

FIG. 14 shows a tubular shaped tensioner arm made of multiple continuous fiber materials.

### DETAILED DESCRIPTION OF THE INVENTION

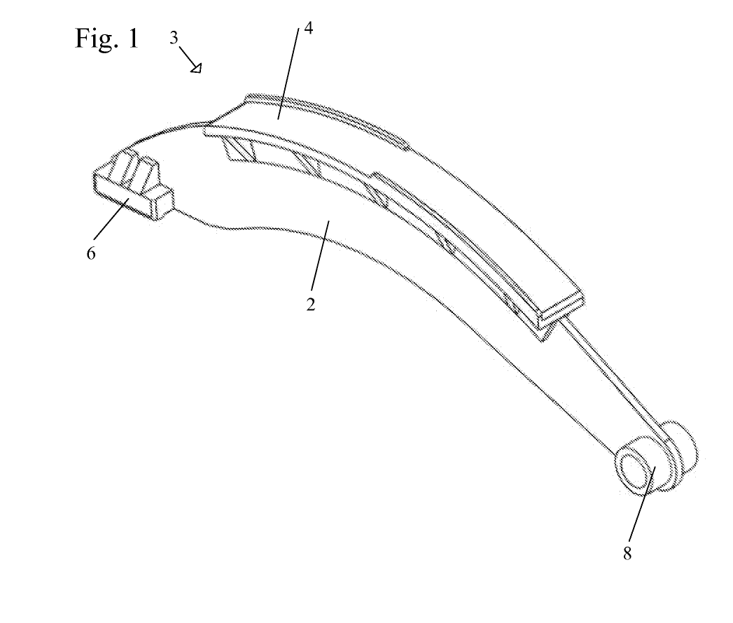

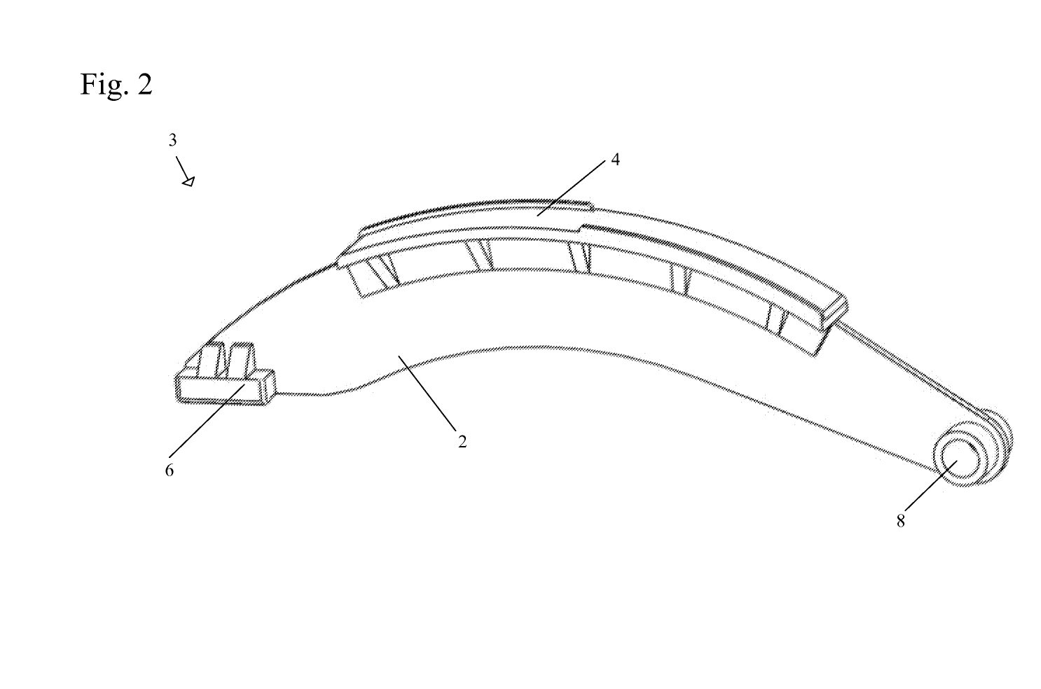

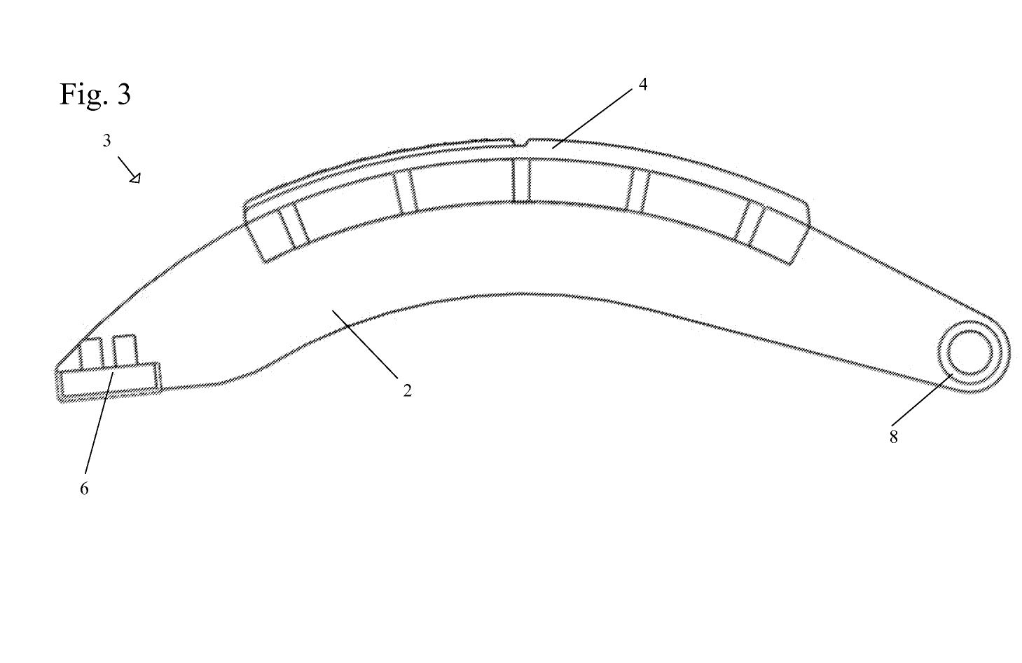

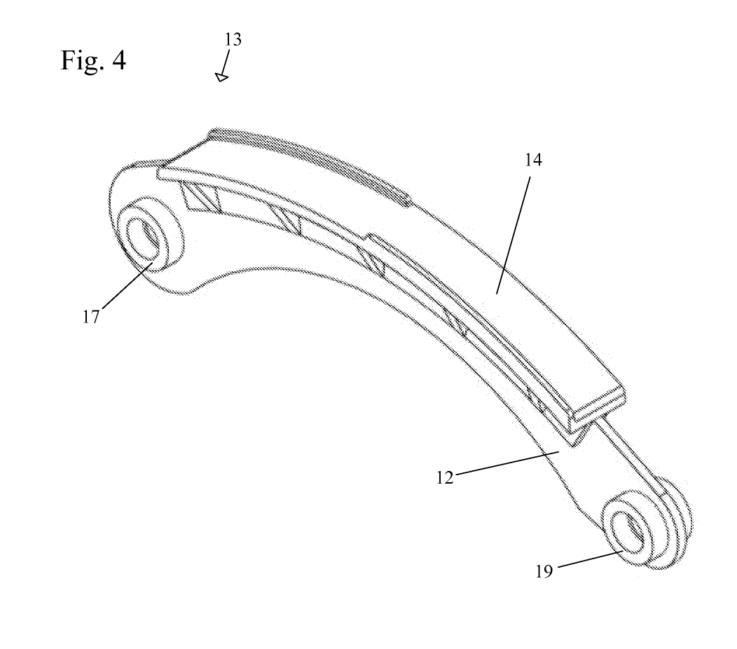

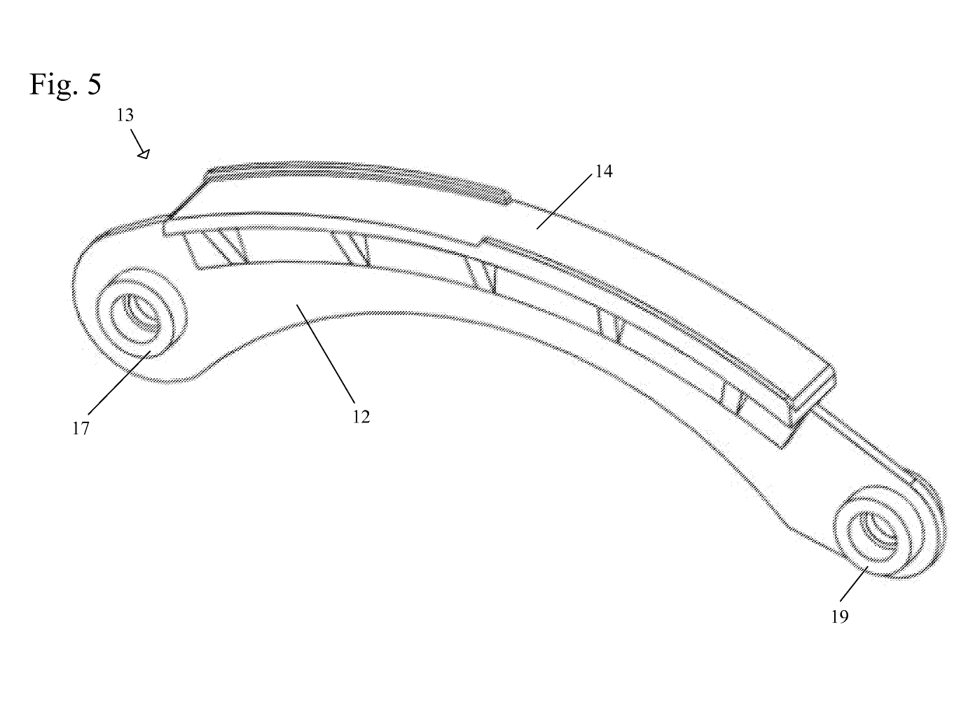

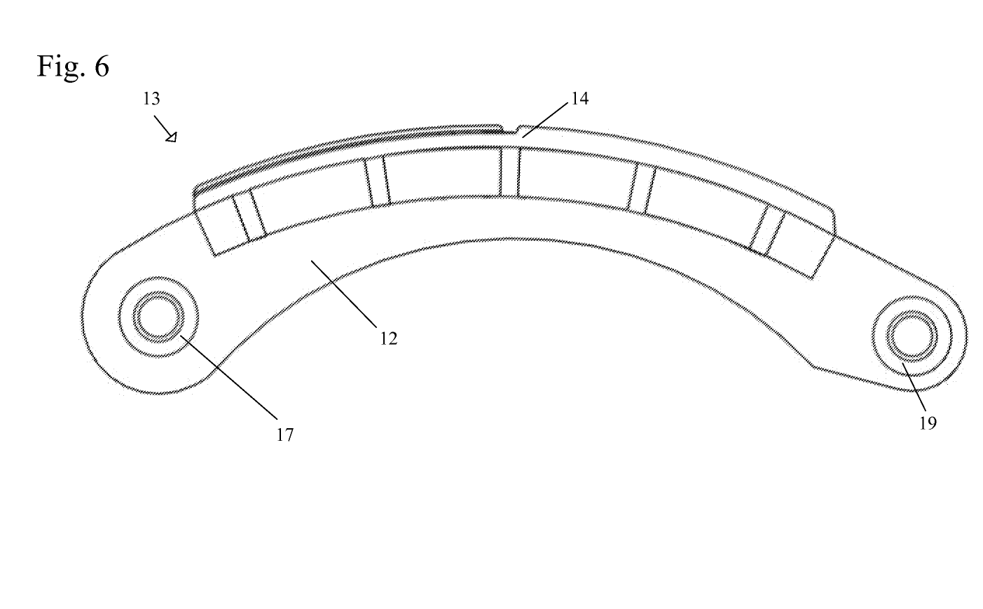

FIGS. 1-3 show a one piece tensioner arm 3 made from continuous fiber materials and FIGS. 4-6 show a one piece guide 13 made from continuous fiber materials. The tensioner arm 3 has a body 2 made from a continuous fiber material 20, for example a unidirectional tape. The continuous fiber material is built up in layers to provide sufficient support of the chain or belt load, for example in bending, shear and torsion. The body 2, 12 replaces a traditional body of an arm 3 or guide 13 of the prior art with the same stiffness or load capacity.

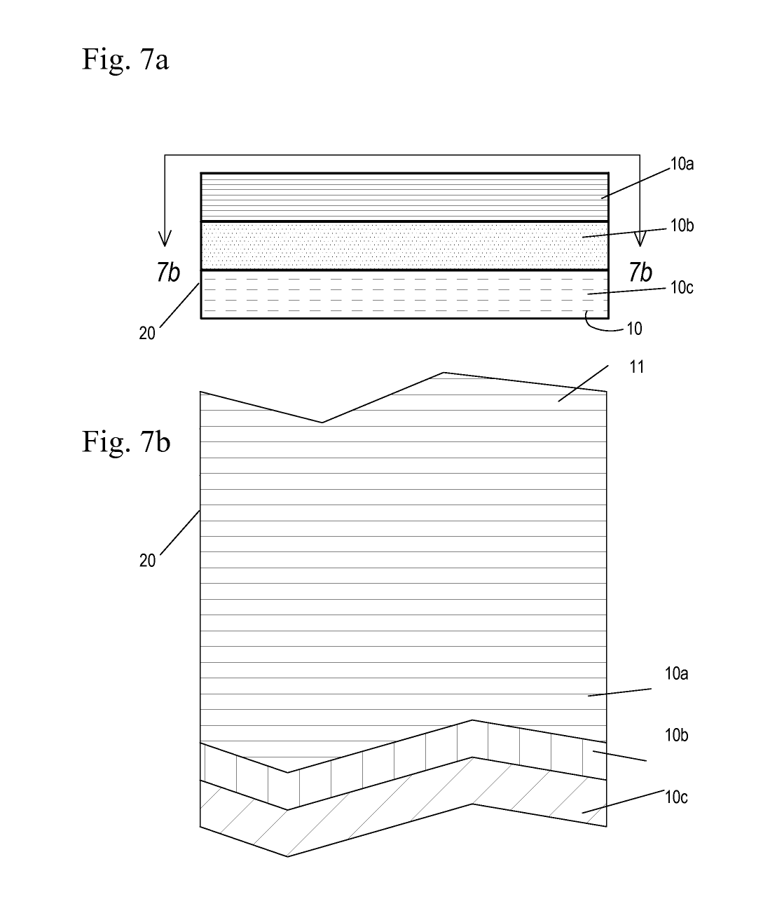

The unidirectional tape or continuous fiber material 20 has fibers 10, for example glass or carbon fiber, in which a majority of the fibers run in a single direction and are held in a thermoplastic substrate 11 as shown in FIGS. 7a-7b. The fibers 10 are preferably straight and uncrimped. Each layer of unidirectional tape 20 is a single ply and therefore has fibers in a single direction (either across the entire length or the entire width of the tape). The direction of the fibers 10 may be varied by varying the direction of the plys and placement of the tape, allowing customizable strength and stiffness for each of the tensioner arms or guides produced. The continuous fiber material 20 offers an increased strength to weight ratio versus resins with short fibers, long fibers and metallic parts.

FIG. 7a shows a side view of a body made of three layers of unidirectional tape 20 layered such that the fibers 10 are placed in a different direction than a previous layer. FIG. 7b shows a cross-section of the body along line 7b-7b. A first layer 10a has the fibers 10 in a horizontal direction relative to the paper (i.e. crossways to the length of the tape). A second layer 10b has the fibers 10 passing into the paper (i.e. along the length of the tape). A third layer 10c has fibers that are layered diagonal relative to the first and second layers 10a, 10b.

Directly attached to the body 2 of the tensioner arm is a chain sliding face 4, a piston pad 6 and a boss 8 for receiving a pivot (not shown). The chain sliding face 4, piston pad 6 and boss 8 for receiving a pivot may be made of thermoplastic resin and may be overmolded onto the body 2. The bond between the body 2 and the chain sliding face 4, piston pad 6 and boss 8 may be through melting and/or chemical adhesion or by mechanical lock through interlock cuts in the body 2. The body 2 may also have the chain sliding face 4, piston pad 6 and boss 8 deposited or “grown” onto the body which acts as a substrate, for example using an additive manufacturing process.

Directly attached to the body 12 of the guide 13, as shown in FIGS. 4-6, is a chain sliding face 14, a first boss 17 at a first end of the body 12 and a second boss 19 at a second end of the body 12 each for receiving a bolt (not shown) for securing the guide 13 to the engine. The chain sliding face 14, first boss 17 and second boss 19 may be made of thermoplastic resin and may be overmolded onto the body 12. The bond between the body 12 and the chain sliding face 14, first boss 17 and second boss 19 may be through melting and/or chemical adhesion or by mechanical lock through interlock cuts in the body 12. The body 12 may also have the chain sliding face 14, first boss 17 and second boss 19 deposited or “grown” onto the body 12 which acts as a substrate, for example using an additive manufacturing process.

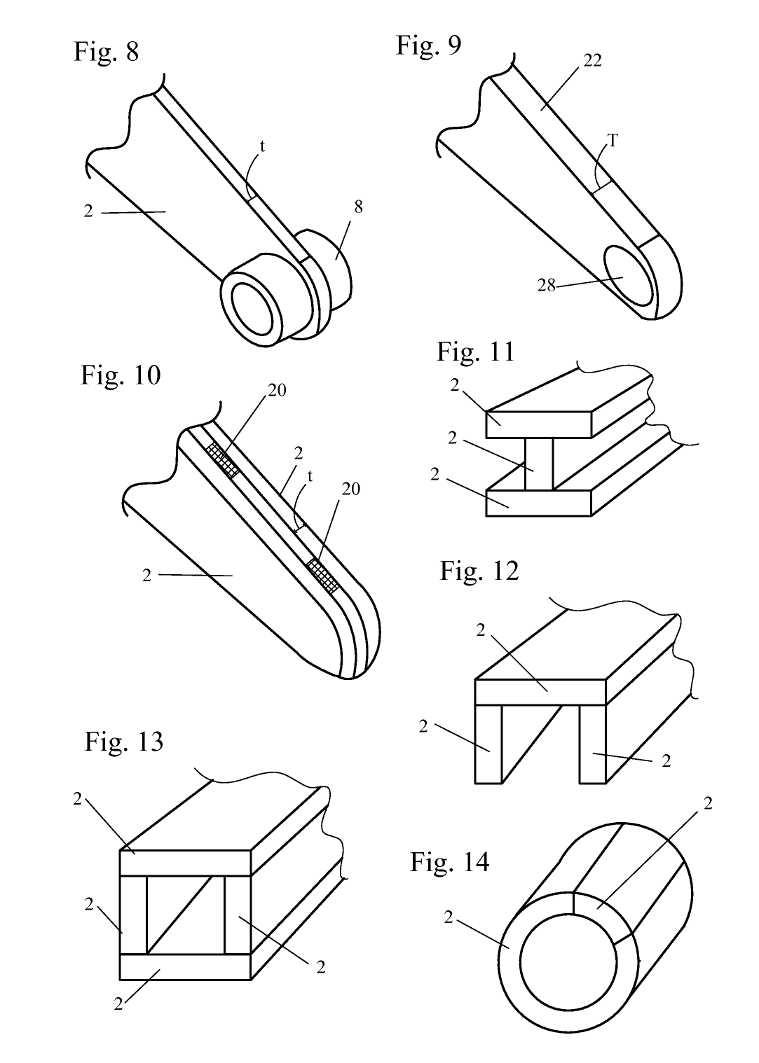

Alternatively, the boss 8 and piston pad 6 may be eliminated if the body 2 of the tensioner arm 3 is increased in thickness. In one embodiment, a single body is increased in thickness. FIG. 9 shows a body 22 which has a thickness T, where the thickness T of the body 22 provides a surface area for adequate contact with a piston and a hole 28 with adequate contact for receiving a pivot, such that the boss 8 and piston pad 6 are not necessary. The thickness T of the body 22 is greater than the thickness t of the body 2 of FIG. 8 which requires a piston pad 6 and a boss 8. While FIG. 9 shows the body 22 as being be either uniform thicker than the body 2 of FIG. 8, only a portion of the body 22 at which receives the boss or is coupled to the piston pad may be increased in thickness.

Alternatively, the body may be made thicker by joining two bodies 2 with a thickness t through additional elements, such as continuous fiber materials 20.

Multiple body 2 pieces of continuous fiber materials 20 may also be joined together to form other tensioner arms or guides that are “I” shaped as shown in FIG. 11, “C” shaped as shown in FIG. 12, box shaped as shown in FIG. 13, or tubular in shape as shown in FIG. 14. The body pieces 2 in each of the examples shown in FIGS. 11-14 may be fixed to each other by melting or by additional continuous fiber tape at the joints between the body pieces.

While FIGS. 8-14 were referenced as being for a tensioner arm 3, the same shapes may also be used with a guide 13.

By forming the tensioner arm or guide of continuous fiber material 20, the package size is reduced by approximately 50 percent. The weight can be reduced by approximately 50 percent, and the expense of having to carry out conventional diecasting or injection molding is reduced. The actual weight and size reduction may vary slightly depending on the system.

It should be noted that the body 2, 12 of the one piece tensioner arm or guide is manufactured by layering and orienting the continuous fiber material 20 or unidirectional tape such that the material can provide sufficient strength in bending, shear and torsion and then cut or otherwise formed to the correct shape of the arm 3 or guide 13 as shown in FIG. 7.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A tensioner arm or guide comprising a body having a plurality of layers of continuous fiber material, each layer having fibers oriented in a single direction and extending a majority of a length or width of the material, the fibers of each of the plurality of layers being oriented in a direction other than the orientation of the fibers of adjoining layers of the plurality of layers.

2. The arm or guide of claim 1, wherein the fibers are glass.

3. The arm or guide of claim 1, wherein the fibers are carbon.

4. The arm or guide of claim 1, further comprising a plurality of bodies coupled through continuous fiber material.

5. The arm or guide of claim 4, wherein the body is “I” shaped.

6. The arm or guide of claim 4, wherein the body is “C” shaped.

7. The arm or guide of claim 4, wherein the body is box shaped.

8. The arm or guide of claim 4, wherein the body is tube shaped.

9. The arm or guide of claim 1, further comprising a contact surface coupled to the body.

10. The arm or guide of claim 9, wherein the body is for a tensioner arm and the contact surface is a piston pad.

11. The arm or guide of claim 9, wherein the contact surface is a sliding surface for receiving a belt or a chain.

12. The arm or guide of claim 9, wherein the contact surface is a boss for receiving a pivot.

13. The arm or guide of claim 9, wherein the contact surface is a boss for receiving a bolt.
